(19) United States
(12) Patent Application Publication
(10) Pub. No.: US 2026/0052218 A1
(43) Pub. Date: Feb. 19, 2026

(54) IMAGE PROCESSING METHOD, ELECTRONIC DEVICE, AND COMPUTER-READABLE STORAGE MEDIUM

(71) Applicant: Beijing Zitiao Network Technology Co., Ltd., Beijing (CN)

(72) Inventors: Hui ZHU, Beijing (CN); Bo Liu, Beijing (CN); Xinghua Zhang, Beijing (CN)

(21) Appl. No.: 19/299,050

(22) Filed: Aug. 13, 2025

(30) Foreign Application Priority Data
Aug. 14, 2024 (CN) 202411117435.4

(51) Int. Cl. H04N 1/46; G06T 5/20; G06V 10/44; H04N 1/60

(52) U.S. Cl. CPC H04N 1/465; G06T 5/20; G06V 10/44; H04N 1/60; G06T 2207/20028

(57) ABSTRACT

The embodiment of the present disclosure relates an image processing method, an electronic device and a computer-readable storage medium, the image processing method, includes: acquiring a first image; detecting a feature region in the first image to obtain a detection result of the feature region; in which the feature region is a region with a specified feature; determining a first transmissivity corresponding to the first image based on the detection result of the feature region; and determining an image de-graying intensity based on the first transmissivity, and performing de-graying processing on the first image according to the image de-graying intensity so as to obtain a second image.

### CROSS-REFERENCE TO RELATED APPLICATION

This application claims the priority to and benefits of the Chinese Patent Application, No. 202411117435.4, which was filed on Aug. 14, 2024. All the aforementioned patent applications are hereby incorporated by reference in their entireties.

### TECHNICAL FIELD

The present disclosure relates an image processing method, an electronic device, and a computer-readable storage medium.

### BACKGROUND

With the development of image processing technology and the improvement of people's aesthetic level, more and more users want to perform optimization processing on original pictures obtained by photographing. Through research, the inventor has found that images obtained by photographing exhibit gray effects on the whole due to the problems of image photographing devices (such as hardware limitation and parameter setting) or photographing environments (such as overcast sky and cloudy sky), and other reasons, and thus it is necessary to perform de-graying processing on such images so as to optimize image color. However, image effects obtained by existing image de-graying methods are not good, which is difficult to meet the needs of the users.

### SUMMARY

In order to solve or at least partially solve the above technical problems, the present disclosure provides an image processing method, an apparatus, a device and a medium.

The embodiment of the present disclosure provides an image processing method, the method includes: acquiring a first image; detecting a feature region in the first image to obtain a detection result of the feature region; in which the feature region is a region with a specified feature; determining a first transmissivity corresponding to the first image based on the detection result of the feature region; and determining an image de-graying intensity based on the first transmissivity, and performing de-graying processing on the first image according to the image de-graying intensity so as to obtain a second image.

Optionally, determining the first transmissivity corresponding to the first image based on the detection result of the feature region, includes: acquiring a dark channel map corresponding to the first image; in case that the detection result of the feature region indicates a presence of the feature region in the first image, determining the first transmissivity corresponding to the first image based on the dark channel map and a comparison result between a region area of the feature region and a preset area threshold; and in case that the detection result of the feature region indicates an absence of the feature region in the first image, determining the first transmissivity corresponding to the first image based on the dark channel map and a preset light intensity.

Optionally, determining the first transmissivity corresponding to the first image based on the dark channel map and the comparison result between the region area of the feature region and the preset area threshold, includes: in case that the region area of the feature region is greater than the preset area threshold, determining a dark channel average value corresponding to the feature region based on the dark channel map, and determining the first transmissivity corresponding to the first image based on the dark channel average value corresponding to the feature region; and in case that the region area of the feature region is not greater than the preset area threshold, determining the first transmissivity corresponding to the first image based on the dark channel map and the preset light intensity.

Optionally, determining the first transmissivity corresponding to the first image based on the dark channel average value corresponding to the feature region, includes: acquiring a second transmissivity corresponding to the feature region based on the dark channel average value corresponding to the feature region; in case that the second transmissivity is greater than a preset transmissivity upper limit value, enabling the first transmissivity corresponding to the first image to be equal to the transmissivity upper limit value; in case that the second transmissivity is less than a preset transmissivity lower limit value, enabling the first transmissivity corresponding to the first image to be equal to the transmissivity lower limit value; and in case that the second transmissivity is between the transmissivity lower limit value and the transmissivity upper limit value, enabling the first transmissivity corresponding to the first image to be equal to the second transmissivity.

Optionally, determining the first transmissivity corresponding to the first image based on the dark channel map and the preset light intensity, includes: determining an intermediate transmissivity corresponding to the first image based on the dark channel map and the preset light intensity; and adjusting the intermediate transmissivity by utilizing a guided filtering algorithm to obtain the first transmissivity.

Optionally, determining the image de-graying intensity based on the first transmissivity, includes: acquiring a de-graying intensity set value, and obtaining a reference transmissivity based on the de-graying intensity set value; and determining the image de-graying intensity based on a maximum value of the reference transmissivity and the first transmissivity.

Optionally, performing the de-graying processing on the first image according to the image de-graying intensity so as to obtain the second image, includes: acquiring a de-graying intensity set value, and performing de-mottling processing on the first image based on the de-graying intensity set value to obtain a first intermediate image; performing de-graying processing on the first intermediate image based on the image de-graying intensity and a preset light intensity to obtain a second intermediate image; and performing color adjustment processing on a feature region in the second intermediate image to obtain the second image.

Optionally, performing the de-mottling processing on the first image based on the de-graying intensity set value, includes: determining a de-mottling intensity based on the de-graying intensity set value; and based on the de-mottling intensity, performing the de-mottling processing on the first image by utilizing a preset bilateral filtering algorithm; in which a total number of an associated point corresponding to a pixel point of the first image adopted in the preset bilateral filtering algorithm is a preset value, and a relative positional relationship between the associated point corresponding to the pixel point and the pixel point is a preset relationship.

Optionally, performing the color adjustment processing on the feature region in the second intermediate image to obtain the second image, includes: performing the color adjustment processing on the feature region based on a preset saturation adjustment curve and/or a preset brightness adjustment curve to obtain the second image.

Optionally, the feature region includes a skin region; and the specified feature includes a skin feature.

The embodiment of the present disclosure further provides an image processing apparatus, which includes: an image acquisition module, configured to acquire a first image; a region detection module, configured to detect a feature region in the first image to obtain a detection result of the feature region; in which the feature region is a region with a specified feature; a transmissivity determination module, configured to determine a first transmissivity corresponding to the first image based on the detection result of the feature region; and a de-graying processing module, configured to determine an image de-graying intensity based on the first transmissivity, and performing de-graying processing on the first image according to the image de-graying intensity so as to obtain a second image.

The embodiment of the present disclosure further provides an electronic device, the electronic device includes: a processor, and a memory for storing executable instructions executable by the processor; the processor is configured for reading executable instructions from the memory and executing the instructions to realize the image processing method provided by the embodiment of the present disclosure.

The embodiment of the present disclosure further provides a computer-readable storage medium, a computer program is stored on the storage medium, and the computer program is configured to execute the image processing method provided by the embodiment of the present disclosure.

It should be understood that what is described in this section is not intended to identify key or important features of the embodiments of the present disclosure, nor is it intended to limit the scope of the present disclosure. Other features of the present disclosure will be easily understood from the following specification.

### BRIEF DESCRIPTION OF DRAWINGS

The accompanying drawings, which are incorporated in and constitute a portion of the specification, illustrate embodiments consistent with the present disclosure, and together with the specification, serve to explain principles of the present disclosure.

In order to more clearly explain the technical scheme in the embodiments of the present disclosure or the prior art, the drawings needed in the description of the present embodiment or the prior art will be briefly introduced below. Obviously, for ordinary people in the field, other drawings can be obtained according to these drawings without paying creative labor.

FIG. 1 is a schematic flow diagram of an image processing method provided in an embodiment of the present disclosure;

FIG. 2 is a schematic diagram of associated points for a bilateral filtering algorithm provided in an embodiment of the present disclosure;

FIG. 3 is a schematic diagram of an adjustment curve provided in an embodiment of the present disclosure;

FIG. 4 is a schematic flow diagram of an image processing method provided in an embodiment of the present disclosure;

FIG. 5 is a schematic diagram of image processing provided in an embodiment of the present disclosure;

FIG. 6 is a schematic structural diagram of an image processing apparatus provided in an embodiment of the present disclosure; and

FIG. 7 is a schematic structural diagram of an electronic device provided in an embodiment of the present disclosure.

### DETAILED DESCRIPTION

In order to understand the above objects, features and advantages of the present disclosure more clearly, the scheme of the present disclosure will be further described below. It should be noted that the embodiments of the present disclosure and the features in the embodiments can be combined with each other without conflict.

In the following description, many specific details are set forth in order to fully understand the present disclosure, but the present disclosure may be implemented in other ways than those described herein; obviously, the embodiments in the specification are only part of the embodiments of the present disclosure, not all of them.

FIG. 1 is a schematic flow diagram of an image processing method provided in an embodiment of the present disclosure. The method may be executed by an image processing apparatus, the apparatus may be implemented by adopting software and/or hardware, and may be generally integrated in an electronic device. As shown in FIG. 1, the method mainly includes the following steps S102 to S108.

Step S102, a first image is acquired. The content of the first image is not limited in the embodiment of the present disclosure, and any image which requires de-graying processing may be taken as the first image. In a practical application, color values of the first image may be normalized to be between 0 and 1 for ease of processing.

Step S104, a feature region in the first image is detected to obtain a detection result of the feature region; the feature region is a region with a specified feature.

In a practical application, a detection processing may be performed on the feature region, for example, may be implemented by adopting a feature region detection algorithm or a feature region segmentation model, so as to obtain the detection result of the feature region, the detection result of the feature region may be configured for indicating whether the feature region is present in the first image, and detected region information about the feature region, and the region information includes but is not limited to a region area of the feature region, a region position of the feature region, and other information. The specified feature is not limited in the embodiment of the present disclosure, the specified feature may be a feature possessed by a body part which is concerned by most of users or a feature possessed by a specific target object, and the specified feature may also be a feature which is greatly affected by the de-graying processing, such as a feature which is likely to be taken as a fog region in the de-graying processing due to a property thereof. Illustratively, the feature region includes a skin region, and the specified feature includes a skin feature. It should be understood that most of the users pay more attention to a skin effect exhibited in the image, and the skin exhibition effect also directly affects the perception and image processing experience of the users, and the skin feature also causes the skin region to be likely to be taken as the fog region. In view of the above reasons, in the embodiment of the present disclosure, the feature region in the image is fully considered during the de-graying processing of the image, and the feature region is detected firstly for subsequent analysis and processing.

Step S106, a first transmissivity corresponding to the first image is determined based on the detection result of the feature region. In some implementations, the transmissivity mentioned in the embodiment of the present disclosure is an atmospheric transmissivity, and the first transmissivity is the atmospheric transmissivity, and the first transmissivity may also be referred to as a first atmospheric transmissivity; in addition, the first transmissivity may also be a numerical value obtained by calculation.

In the related art, the transmissivity is generally determined directly for a full map, without considering a local region, and the transmissivity of the full map is determined with sufficient reference to the detection result of the feature region in the embodiment of the present disclosure. Illustratively, the first transmissivity corresponding to the first image may be determined by adopting different strategies based on information such as whether the feature region is detected, and the detected size of the region area of the feature region, thereby ensuring the accuracy and reliability of the first transmissivity.

Step S108, an image de-graying intensity is determined based on the first transmissivity, and de-graying processing is performed on the first image according to the image de-graying intensity so as to obtain a second image.

The transmissivity generally has an associated relationship with the de-graying intensity, and a magnitude of the transmissivity directly affects a magnitude of the de-graying intensity. In the embodiment of the present disclosure, the image de-graying intensity can be determined based on the first transmissivity, so that the de-graying processing is performed on the first image according to the image de-graying intensity. It should be noted that the de-graying processing may be directly performed on the first image according to the image de-graying intensity, or a pre-processing may be firstly performed on the first image, and then the de-graying processing is performed on a pre-processed first image according to the image de-graying intensity, so as to obtain the second image; and the pre-processing is not limited in the embodiment of the present disclosure, and illustratively, the pre-processing includes de-mottling processing.

For the above technical solution provided by the embodiment of the present disclosure, it is fully considered that the feature region having the specified feature may be a region more concerned by the user, and a de-graying effect thereof may have a greater impact on the perception of the user. Therefore, in response to that the de-graying processing is performed on the first image, the first transmissivity corresponding to the first image is determined in combination with the detection result of the feature region, so as to determine a reasonable image de-graying intensity, which is conducive to ensuring the de-graying effect of the second image on the whole, and on this basis, the feature region after de-graying can also be caused to exhibit better perception of the user, thereby better satisfying the needs of the user.

In some implementations, step S106, namely, the step of determining the first transmissivity corresponding to the first image based on the detection result of the feature region, may be executed with reference to the following step A to step C.

Step A, a dark channel map corresponding to the first image is acquired. The dark channel map is configured for indicating a dark channel value corresponding to each pixel point in the first image, and a mode of acquiring the dark channel map is not limited in the embodiment of the present disclosure, for example, the dark channel map may be acquired by adopting an image minimum filtering algorithm, and reference may be specifically made to the related art, which will not be described in detail herein.

Step B, the first transmissivity corresponding to the first image is determined based on the dark channel map and a comparison result between a region area of the feature region and a preset area threshold in case that the detection result of the feature region indicates the presence of the feature region in the first image. Namely, in the embodiment of the present disclosure, the region area of the feature region is considered, the size of the region area also affects a determination mode of the first transmissivity, and this mode of determining the first transmissivity based on the comparison result between the region area and the preset area threshold is also more reasonable; the preset area threshold may be flexibly set according to needs, which is not limited herein.

In some specific implementation examples, the implementation may be based on the following step B1 and step B2.

Step B1, a dark channel average value corresponding to the feature region is determined based on the dark channel map and the first transmissivity corresponding to the first image is determined based on the dark channel average value corresponding to the feature region in case that the region area of the feature region is greater than the preset area threshold. Namely, the transmissivity of the feature region may be determined by directly adopting the dark channel average value corresponding to the feature region in case that the area of the feature region is relatively large, and then the transmissivity of the feature region is taken as the first transmissivity corresponding to the first image. It should be understood that the transmissivity determined by taking the feature region as a benchmark in case that the area of the feature region is relatively large may effectively ensure that the finally obtained de-graying effect satisfies the needs, and the obtained feature region in the second image can exhibit a satisfactory visual effect. The dark channel average value corresponding to the feature region is a value obtained by averaging respective pixel values of all pixel points in the feature region.

The transmissivity of the feature region determined by adopting the obtained dark channel average value corresponding to the feature region is also a value which may be uniformly applied to the first image, namely, the target transmissivities corresponding to all the pixel points in the first image are enabled to be equal to the transmissivity of the feature region. In the embodiment of the present disclosure, the mode of determining the transmissivity of the feature region based on the dark channel average value corresponding to the feature region is not limited, and the specific implementation example of determining the first transmissivity corresponding to the first image based on the dark channel average value corresponding to the feature region in step B1 may be implemented with reference to the following (1) to (4).
(1) A second transmissivity corresponding to the feature region is acquired based on the dark channel average value corresponding to the feature region. Illustratively, the second transmissivity is a second atmospheric transmissivity. The second transmissivity has a negative correlation with the dark channel average value. Illustratively, the second transmissivity corresponding to the feature region may be obtained with reference to the following mode: tv=a−b*(s−c); wherein a, b and c are all preset fixed parameter values being between 0 and 1, which may be flexibly set specifically according to needs, and s represents the dark channel average value corresponding to the feature region. In a practical application, the determination of the transmissivity based on the dark channel average value may also be implemented in other modes, which is not limited herein.
(2) In case that the second transmissivity is greater than a preset transmissivity upper limit value, the first transmissivity corresponding to the first image is enabled to be equal to the transmissivity upper limit value.
(3) In case that the second transmissivity is less than a preset transmissivity lower limit value, the first transmissivity corresponding to the first image is enabled to be equal to the transmissivity lower limit value.
(4) In case that the second transmissivity is between the transmissivity lower limit value and the transmissivity upper limit value, the first transmissivity corresponding to the first image is enabled to be equal to the second transmissivity.

In order to control the first transmissivity to be within a reasonable range, in the embodiment of the present disclosure, the transmissivity upper limit value and the transmissivity lower limit value are set to constrain the first transmissivity, in response to the second transmissivity obtained by calculation being between the transmissivity upper limit value and the transmissivity lower limit value, the second transmissivity may be directly taken as the first transmissivity of the first image, and in response to the second transmissivity being outside the transmissivity upper limit value and the transmissivity lower limit value, a corresponding transmissivity threshold value is taken as the first transmissivity of the first image. By the above mode, the effectiveness of the finally obtained first transmissivity may be ensured, and the de-graying effect of the second image may be prevented from being affected by too dark or too bright pixel points caused by a too high or too low first transmissivity.

Step B2, the first transmissivity corresponding to the first image is determined based on the dark channel map and the preset light intensity in case that the region area of the feature region is not greater than the preset area threshold. Illustratively, the foregoing light intensity may specifically be an atmospheric light intensity. Namely, in case that the region area of the feature region is relatively small, in order to ensure the overall de-graying effect of the full map, the first transmissivity corresponding to the first image may be determined by directly utilizing the dark channel map and the light intensity without considering the impact of the feature region, and specifically, the first transmissivity corresponding to the first image includes the first transmissivity corresponding to each pixel point in the first image. Reference may be made to the related art for the mode of determining the transmissivity by utilizing the dark channel map and the light intensity, for example, a processing may be performed by utilizing the image minimum filtering algorithm, which will not be described in detail herein. It should be noted that the light intensity in the embodiment of the present disclosure is not obtained by calculation, but a preset value is adopted, this mode may avoid an uncontrollable situation which may occur in a conventional light intensity calculation mode, and the mode of adopting the preset light intensity has higher robustness; and illustratively, the preset light intensity A=[0.8, 0.8, 0.8].

In the specific implementation example of determining the first transmissivity corresponding to the first image based on the dark channel map and the preset light intensity in step B2, reference may be made to the following step 1 to step 2 for implementation.

Step 1, an intermediate transmissivity corresponding to the first image is determined based on the dark channel map and the preset light intensity. For example, an intermediate transmissivity corresponding to each pixel point in the first image is determined by utilizing the image minimum filtering algorithm based on the dark channel map and the preset light intensity, and illustratively, the intermediate transmissivity may be an intermediate atmospheric transmissivity. Reference may be made to the related art for the specific mode of determining the transmissivity based on the dark channel map and the light intensity, which is not limited herein.

Step 2, the intermediate transmissivity is adjusted by utilizing a guided filtering algorithm to obtain the first transmissivity. In order to further optimize the intermediate transmissivity, in the embodiment of the present disclosure, the intermediate transmissivity is also adjusted by adopting the guided filtering algorithm, so as to ensure the accuracy of the first transmissivity. Illustratively, a filtering kernel size corresponding to the guided filtering algorithm is greater than a filtering kernel size corresponding to the minimum filtering algorithm adopted for determining the intermediate transmissivity in step 1, for example, the filtering kernel size corresponding to the guided filtering algorithm is eight times the filtering kernel size corresponding to the minimum filtering algorithm for determining the intermediate transmissivity. The above mode is conducive to eliminating halos and improving the fineness of the image.

Step C, the first transmissivity corresponding to the first image is determined based on the dark channel map and a preset light intensity in case that the detection result of the feature region indicates the absence of the feature region in the first image.

The above implementation mode of determining the first transmissivity corresponding to the first image based on the dark channel map and the preset light intensity in step C may be executed with reference to the foregoing step 1 and step 2, which will not be described in detail herein.

In some embodiments, the step of determining the image de-graying intensity based on the first transmissivity in step S108 may be executed with reference to the following step 1 to step 2.

Step 1, a de-graying intensity set value is acquired, and a reference transmissivity is obtained based on the de-graying intensity set value. Illustratively, the reference transmissivity may be a reference atmospheric transmissivity.

In a practical application, a user may be provided with a control for setting the de-graying intensity set value, and the control may be a parameter input control or a slide bar control, and the like, which is not limited. The de-graying intensity set value (a numerical value between 0 and 1) set by the user may be obtained by the control, and the de-graying intensity set value has a direct relationship with the reference transmissivity. In some implementation examples, according to a conventional understanding mode of the user, the greater the de-graying intensity set value is, the more intense the desire of the user for performing the de-graying processing with a relatively strong force on the image typically is, and the more obvious the de-graying effect of the image is. However, considering that in a practical application, the greater the transmissivity is, the lower the corresponding de-graying intensity is, the transmissivity is between 0 and 1, and assuming that the transmissivity is 1, it is indicated that the de-graying intensity is 0, and there is no de-graying effect at all; and the less the transmissivity is, the higher the corresponding de-graying intensity is. To this end, it is possible to enable that the reference transmissivity is equal to 1 minus the de-graying intensity set value, for example, assuming that the de-graying intensity set value input by the user is 0.1, it is indicated that the reference transmissivity is 0.9.

Step 2, the image de-graying intensity is determined based on a maximum value of the reference transmissivity and the first transmissivity. The image de-graying intensity includes an image de-graying intensity corresponding to each pixel point in the first image, namely, for each pixel point in the first image, the first transmissivity corresponding to the pixel point is compared with the reference transmissivity, and the maximum value between the two is taken as the image de-graying intensity corresponding to the pixel point. In the above mode of taking the maximum value, a lower limit of the image de-graying intensity may be constrained, for example, the lower limit value is at least the reference transmissivity obtained based on the setting of the user, in other words, the reference transmissivity obtained based on the setting of the user may be used for limiting the minimum transmissivity. Illustratively, assuming that the target transmissivities of all pixel points corresponding to the first image are in a range of 0.2 to 1 and the de-graying intensity set value (such as a slide bar value) is 0.1, the minimum transmissivity is the reference transmissivity of 0.9, the corrected transmissivity is 0.9 to 1, and then the image de-graying intensity corresponding to each pixel point in the first image is obtained based on the corrected transmissivity corresponding to the first image, for example, in a range of 0 to 0.1.

In some embodiments, the step of performing the de-graying processing on the first image according to the image de-graying intensity so as to obtain the second image in step S108 may be executed with reference to the following step a to step c.

Step a, the de-graying intensity set value is acquired, and the de-mottling processing is performed on the first image based on the de-graying intensity set value to obtain a first intermediate image.

In some specific implementation examples of performing the de-mottling processing on the first image based on the de-graying intensity set value, a de-mottling intensity may be firstly determined based on the de-graying intensity set value, and then the de-mottling processing is performed on the first image by utilizing a preset bilateral filtering algorithm based on the de-mottling intensity. Illustratively, the de-mottling intensity is positively correlated with the de-graying intensity set value, for example, the de-mottling intensity is equal to the de-graying intensity set value. The bilateral filtering algorithm can effectively retain edge information of the image simultaneously in response to smoothing the image and reducing the noise, so as to achieve a better de-mottling effect.

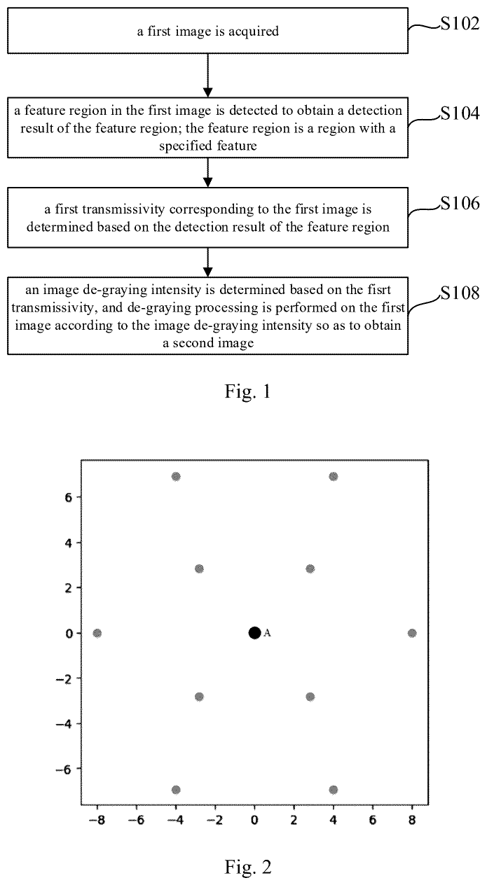

Further, the bilateral filtering algorithm adopted in the example of the present disclosure is an improvement on an existing bicolor filtering algorithm, and specifically, in the preset bilateral filtering algorithm adopted in the embodiment of the present disclosure, the total number of associated points corresponding to pixel point of the first image adopted is a preset value, and relative positional relationships between the associated points corresponding to the pixel point and the pixel point are preset relationships. It should be understood that the bilateral filtering algorithm generally requires the associated point corresponding to each pixel point to determine a color value of the pixel point, while the associated points corresponding to the pixel points of the first image adopted in the existing bilateral filtering algorithm are all the pixel points in the first image, namely, a corresponding color value of each pixel point is required to be determined based on all the pixel points in the image, but this mode requires a great amount of calculation, has relatively high requirements for the performance of a device, is inconvenient to apply to a mobile terminal, and has a low processing efficiency. To this end, in the embodiment of the present disclosure, the number of the associated points corresponding to the pixel points is directly preset, and the relative positional relationship between each associated point and the pixel point is set, so that the corresponding associated point, which may also be referred to as a sampling point, may be determined accurately and conveniently based on each pixel point in the first image. In order to facilitate understanding, reference may be made to a schematic diagram of associated points of the bilateral filtering algorithm shown in FIG. 2, by taking a black point A being a current pixel point (namely, a central point) with a color value to be determined as an example, it is only necessary to determine 10 associated points (namely, gray points) corresponding to the central point based on the preset relative positional relationships, and then obtain the color value of the black point A based on color values of the 10 associated points and the relative positional relationships between the associated points and the black point A. The above mode may greatly reduce the amount of calculation for the de-mottling processing and improve the efficiency of the de-mottling processing.

Step b, de-graying processing is performed on the first intermediate image based on the image de-graying intensity and the preset light intensity to obtain a second intermediate image.

Specifically, for each pixel point in the first intermediate image, a difference value between a color value of the pixel point and a preset light intensity is acquired, then a ratio between the difference value and a transmissivity corresponding to an image de-graying intensity corresponding to the pixel point is calculated, afterwards the ratio is summed with the light intensity to obtain a target color value of the pixel point, and the second intermediate image may be obtained based on the target color values corresponding to all the pixel points.

Step c, color adjustment processing is performed on a feature region in the second intermediate image to obtain the second image.

In order to further optimize the visual perception of the feature region, for example, improve poor saturation or brightness of the feature region, in the embodiment of the present disclosure, the color adjustment processing is further performed on the feature region in the second intermediate image on the basis of obtaining the second intermediate image, so as to obtain the second image with a better de-graying effect and better visual perception of the feature region.

Illustratively, the color adjustment processing may be performed on the feature region based on a preset saturation adjustment curve and/or a preset brightness adjustment curve to obtain the second image. The saturation adjustment curve and the brightness adjustment curve may be set flexibly according to the needs. In the above mode, the color value of the feature region may be optimized conveniently and quickly, so as to meet the needs of the user.

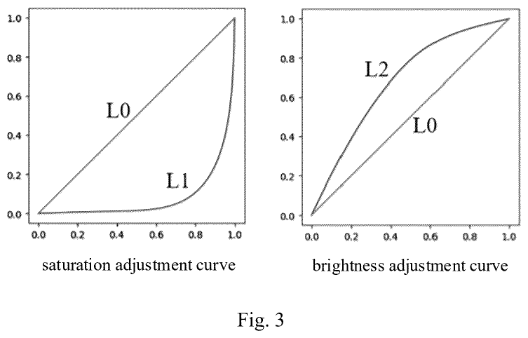

In order to facilitate understanding, illustratively, with reference to a schematic diagram of the adjustment curve shown in FIG. 3, the saturation adjustment curve and the brightness adjustment curve are illustrated simultaneously. By taking the saturation adjustment curve as an example, a horizontal ordinate is used for indicating existing saturation, a longitudinal coordinate is used for indicating adjusted saturation, L0 represents no adjustment, namely, the horizontal ordinate is consistent with the longitudinal coordinate, L1 represents the saturation adjustment curve for indicating that the saturation corresponding to the horizontal ordinate is changed to the saturation corresponding to the longitudinal coordinate; the saturation may be obtained by calculation based on an RGB value of the pixel, and a corrected RGB value may be obtained by conversion after corrected saturation is finally obtained. The brightness adjustment curve is also similar, L2 represents the brightness adjustment curve for indicating that the brightness corresponding to the horizontal ordinate is changed to the brightness corresponding to the longitudinal coordinate; the brightness may be obtained by calculation based on the RGB value of the pixel, and the corrected RGB value may be obtained by conversion after corrected brightness is finally obtained. In a practical application, the color adjustment may be performed by flexibly adopting the saturation adjustment curve and/or the brightness adjustment curve according to needs, so as to ameliorate the problem of poor saturation or brightness of the feature region caused by the de-graying processing.

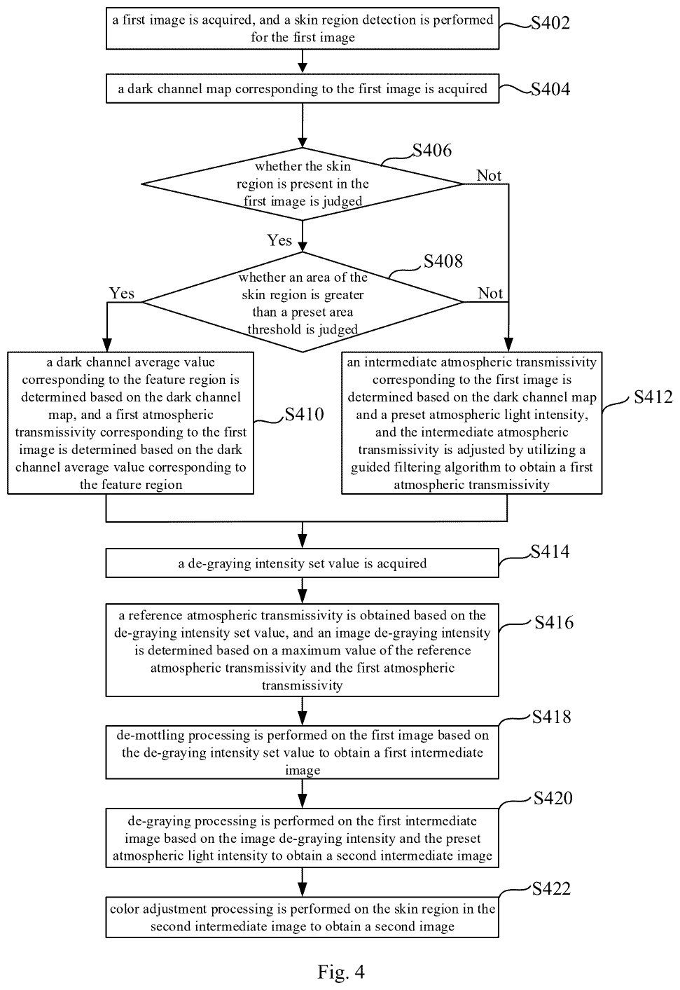

Further, an embodiment of the present disclosure provides an image processing method, and in the method, by taking the foregoing first transmissivity being specifically the first atmospheric transmissivity, the foregoing light intensity being specifically the atmospheric light intensity, the foregoing intermediate transmissivity being specifically the intermediate atmospheric transmissivity, and the foregoing reference transmissivity being specifically the reference atmospheric transmissivity as an example for illustration, FIG. 4 is a schematic flow diagram of an image processing method provided in an embodiment of the present disclosure, which mainly includes the following step S402 to step S422.

Step S402, a first image is acquired, and a skin region detection is performed for the first image, in this example, the skin region corresponds to the foregoing feature region.

Step S404, a dark channel map corresponding to the first image is acquired.

Step S406, whether the skin region is present in the first image is judged; in response to that the result is yes, step S408 is executed, and in response to that the result is not, step S412 is executed.

Step S408, whether an area of the skin region is greater than a preset area threshold is judged; in response to that the result is yes, step S410 is executed, and in response to that the result is not, step S412 is executed.

Step S410, a dark channel average value corresponding to the feature region is determined based on the dark channel map, and a first atmospheric transmissivity corresponding to the first image is determined based on the dark channel average value corresponding to the feature region. Afterwards, step S414 is executed.

Step S412, an intermediate atmospheric transmissivity corresponding to the first image is determined based on the dark channel map and a preset atmospheric light intensity, and the intermediate atmospheric transmissivity is adjusted by utilizing a guided filtering algorithm to obtain a first atmospheric transmissivity. Afterwards, step S414 is executed.

Step S414, a de-graying intensity set value is acquired.

Step S416, a reference atmospheric transmissivity is obtained based on the de-graying intensity set value, and an image de-graying intensity is determined based on a maximum value of the reference atmospheric transmissivity and the first atmospheric transmissivity.

Step S418, de-mottling processing is performed on the first image based on the de-graying intensity set value to obtain a first intermediate image.

Step S420, de-graying processing is performed on the first intermediate image based on the image de-graying intensity and the preset atmospheric light intensity to obtain a second intermediate image.

Step S422, color adjustment processing is performed on the skin region in the second intermediate image to obtain a second image.

Reference may be made to the foregoing related contents for specific implementations of the above steps, which will not be described in detail herein. The above mode is conducive to ensuring the de-graying effect of the second image on the whole, and on this basis, the skin region after de-graying can also be caused to exhibit better perception of the user, thereby better satisfying the needs of the user.

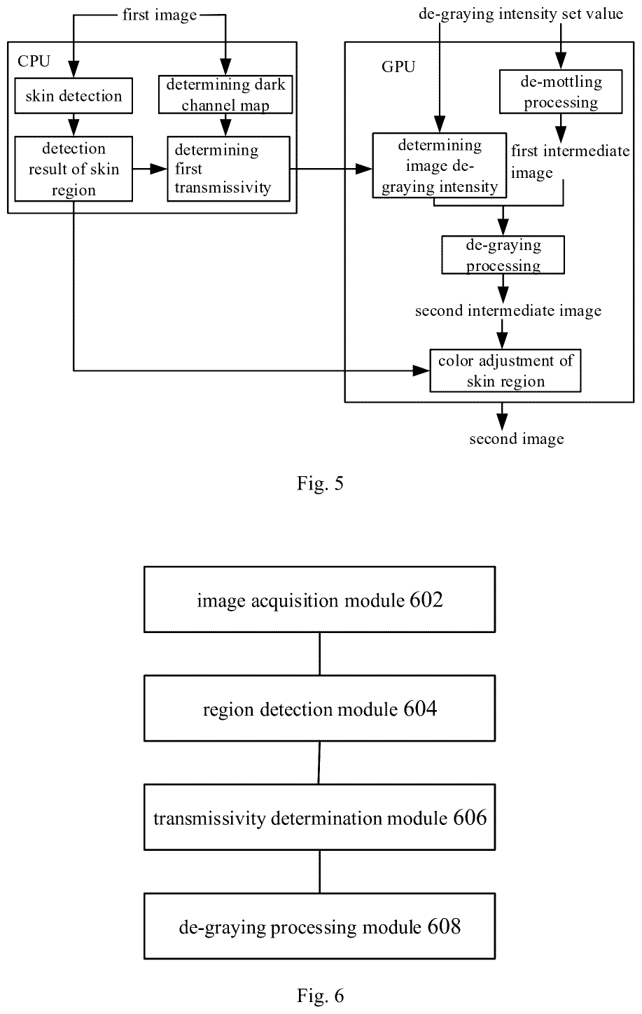

On the basis of the foregoing, FIG. 5 is a schematic diagram of image processing provided in an embodiment of the present disclosure, which illustrates that the image processing method in the embodiment of the present disclosure may be implemented by utilizing a Central Processing Unit (CPU) and a Graphics Processing Unit (GPU) in an electronic device in cooperation, and illustrates that the CPU requires to perform a skin detection processing based on the first image (input image) and obtain the detection result of the skin region, and meanwhile the CPU also requires to determine the dark channel map based on the first image and determine the first transmissivity in combination with the detection result of the skin region, and then the CPU may provide detection information of the skin region and the first transmissivity to the GPU. The GPU may perform de-mottling processing based on the first image and the de-graying intensity set value to obtain the first intermediate image, determine the image de-graying intensity based on the de-graying intensity set value and the first transmissivity, so as to perform the de-graying processing on the first intermediate image based on the image de-graying intensity to obtain the second intermediate image, and then perform a color adjustment of the skin region for the second intermediate image to obtain the second image.

In summary, for the above technical solution provided in the embodiment of the present disclosure, it is fully considered that the feature region having the specified feature may be a region more concerned by the user, and a de-graying effect thereof may have a greater impact on the perception of the user. Therefore, in response to the de-graying processing is performed on the first image, the first transmissivity corresponding to the first image is determined in combination with the detection result of the feature region, so as to determine a reasonable image de-graying intensity, which is conducive to ensuring the de-graying effect of the second image on the whole, and on this basis, the feature region after de-graying can also be caused to exhibit better perception of the user, thereby better satisfying the needs of the user.

An embodiment of the present disclosure further provides an image processing apparatus corresponding to the foregoing image processing method. FIG. 6 is a schematic structural diagram of an image processing apparatus provided in an embodiment of the present disclosure. The apparatus may be implemented by software and/or hardware, and may be generally integrated in an electronic device. As shown in FIG. 6, the image processing apparatus includes:
an image acquisition module 602, configured for acquiring a first image;
a region detection module 604, configured for detecting a feature region in the first image to obtain a detection result of the feature region; in which the feature region is a region with a specified feature;
a transmissivity determination module 606, configured for determining a first transmissivity corresponding to the first image based on the detection result of the feature region; and
a de-graying processing module 608, configured for determining an image de-graying intensity based on the first transmissivity, and performing de-graying processing on the first image according to the image de-graying intensity so as to obtain a second image.

For the above apparatus provided in the example of the present disclosure, it is fully considered that the feature region having the specified feature may be a region more concerned by the user, and a de-graying effect thereof may have a greater impact on the perception of the user. Therefore, in response to that the de-graying processing is performed on the first image, the first transmissivity corresponding to the first image is determined in combination with the detection result of the feature region, so as to determine a reasonable image de-graying intensity, which is conducive to ensuring the de-graying effect of the second image on the whole, and on this basis, the feature region after de-graying can also be caused to exhibit better perception of the user, thereby better satisfying the needs of the user.

In some implementations, the transmissivity determination module 606 is specifically configured for: acquiring a dark channel map corresponding to the first image; in case that the detection result of the feature region indicates a presence of the feature region in the first image, determining the first transmissivity corresponding to the first image based on the dark channel map and a comparison result between a region area of the feature region and a preset area threshold; and in case that the detection result of the feature region indicates an absence of the feature region in the first image, determining the first transmissivity corresponding to the first image based on the dark channel map and a preset light intensity.

In some implementations, the transmissivity determination module 606 is specifically configured for: in case that the region area of the feature region is greater than the preset area threshold, determining a dark channel average value corresponding to the feature region based on the dark channel map, and determining the first transmissivity corresponding to the first image based on the dark channel average value corresponding to the feature region; and in case that the region area of the feature region is not greater than the preset area threshold, determining the first transmissivity corresponding to the first image based on the dark channel map and the preset light intensity.

In some implementations, the transmissivity determination module 606 is specifically configured for: acquiring a second transmissivity corresponding to the feature region based on the dark channel average value corresponding to the feature region; in case that the second transmissivity is greater than a preset transmissivity upper limit value, enabling the first transmissivity corresponding to the first image to be equal to the transmissivity upper limit value; in case that the second transmissivity is less than a preset transmissivity lower limit value, enabling the first transmissivity corresponding to the first image to be equal to the transmissivity lower limit value; and in case that the second transmissivity is between the transmissivity lower limit value and the transmissivity upper limit value, enabling the first transmissivity corresponding to the first image to be equal to the second transmissivity.

In some implementations, the transmissivity determination module 606 is specifically configured for: determining an intermediate transmissivity corresponding to the first image based on the dark channel map and the preset light intensity; and adjusting the intermediate transmissivity by utilizing a guided filtering algorithm to obtain the first transmissivity.

In some implementations, the de-graying processing module 608 is specifically configured for: acquiring a de-graying intensity set value, and obtaining a reference transmissivity based on the de-graying intensity set value; and determining the image de-graying intensity based on a maximum value of the reference transmissivity and the first transmissivity.

In some implementations, the de-graying processing module 608 is specifically configured for: acquiring a de-graying intensity set value, and performing de-mottling processing on the first image based on the de-graying intensity set value to obtain a first intermediate image; performing de-graying processing on the first intermediate image based on the image de-graying intensity and a preset light intensity to obtain a second intermediate image; and performing color adjustment processing on a feature region in the second intermediate image to obtain the second image.

In some implementations, the de-graying processing module 608 is specifically configured for: determining a de-mottling intensity based on the de-graying intensity set value; and based on the de-mottling intensity, performing the de-mottling processing on the first image by utilizing a preset bilateral filtering algorithm; in which a total number of an associated point corresponding to a pixel point of the first image adopted in the preset bilateral filtering algorithm is a preset value, and a relative positional relationship between the associated point corresponding to the pixel point and the pixel point is a preset relationship.

In some implementations, the de-graying processing module 608 is specifically configured for: performing the color adjustment processing on the feature region based on a preset saturation adjustment curve and/or a preset brightness adjustment curve to obtain the second image.

In some implementations, the feature region includes a skin region; and the specified feature includes a skin feature.

The image processing apparatus provided by the embodiment of the present disclosure can execute the image processing method provided by any embodiment of the present disclosure, and has corresponding functional modules for executing the method and beneficial effects.

It can be clearly understood by those skilled in the art that for the convenience and conciseness of description, the specific working process of the apparatus embodiment described above can refer to the corresponding process in the method embodiment, and will not be repeated here.

An embodiment of the present disclosure provides an electronic device, which includes: a storage apparatus, in which a computer program is stored on the storage apparatus; and a processing apparatus, configured to execute the computer program stored on the storage apparatus to implement steps of any method in the present disclosure.

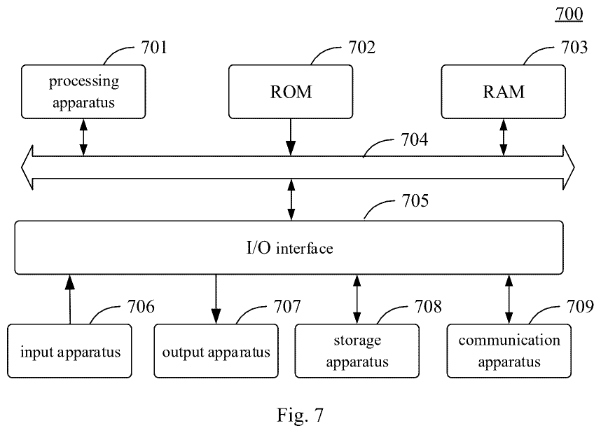

Reference is made to FIG. 7, which shows a structural schematic diagram of an electronic device 700 suitable for implementing the embodiment of the present disclosure. A terminal device in the embodiment of the present disclosure may include but not limited to a mobile terminal such as a mobile phone, a notebook computer, a digital radio broadcasting receiver, a personal digital assistant (PDA), a portable android device (PAD), a portable multimedia player (PMP), a vehicle terminal (such as a vehicle navigation terminal), and a fixed terminal such as a digital television (TV) and a desktop computer. The electronic device shown in FIG. 7 is only an example and should not impose any limitations on the functions and usage scopes of the embodiments of the present disclosure.

As shown in FIG. 7, the electronic device 700 may include a processing apparatus (such as a central processing unit, a graphics processor, and the like) 701, which may execute various appropriate actions and processes according to a program stored in a read-only memory (ROM) 702 or a program loaded from a storage apparatus 708 to a random-access memory (RAM) 703. In the RAM 703, various programs and data required for operations of the electronic device 700 are further stored. The processing apparatus 701, the ROM 702, and the RAM 703 are connected to each other by a bus 704. An input/output (I/O) interface 705 is also connected to the bus 704.

Generally, the following apparatuses may be connected to the I/O interface 705: an input apparatus 706 such as a touch screen, a touch pad, a keyboard, a mouse, a camera, a microphone, an accelerometer, a gyroscope, etc.; an output apparatus 707 such as a liquid crystal display (LCD), a loudspeaker, a vibrator, etc.; a storage apparatus 708 such as a magnetic tape, and a hard disk, etc.; and a communication apparatus 709. The communication apparatus 709 may allow the electronic device 700 to perform wireless or wire communication with other devices to exchange data. Although FIG. 7 shows the electronic device 700 with various apparatuses, it should be understood that it is not required to implement or possess all the apparatuses shown. It may implement alternatively or possess the more or less apparatuses.

In particular, according to the embodiment of the present disclosure, the process described above with reference to the flowcharts may be achieved as a computer software program. For example, an embodiment of the present disclosure includes a computer program product, the computer program product includes a computer program loaded on a non-transitory computer-readable medium, and the computer program contains program codes for executing the method shown in the flowcharts. In such an embodiment, the computer program may be downloaded and installed from the network by the communication apparatus 709, or installed from the storage apparatus 708, or installed from ROM 702. When the computer program is executed by the processing apparatus 701, the above functions in the method in the embodiments of the present disclosure are executed.

In addition to the above methods and devices, the embodiment of the present disclosure may further be a computer program product, which includes a computer program instruction, and in response to the computer program instruction is executed by a processor, the processor is enabled to execute the image processing method provided by the embodiment of the present disclosure. The computer program product may write program codes for performing operations of the embodiment of the present disclosure in a combination of one or more programming languages, the programming languages include object-oriented programming languages such as Java and C++, and the like, and further include conventional procedural programming languages such as “C” programming language or similar programming languages. The program codes may be entirely executed on a user's computer, partially executed on the user's computer, executed as an independent software package, partially executed on the user's computer and partially executed on a remote computer, or entirely executed on the remote computer or a server.

In addition, the embodiment of the present disclosure can further be a computer-readable storage medium, on which a computer program instruction is stored, and the computer program instruction, in response to being executed by a processor, is configured to cause the processor to execute the image processing method provided by the embodiment of the present disclosure.

The computer-readable storage medium can adopt any combination of one or more readable medium. The readable medium may be a readable signal medium or a readable storage medium. The readable storage medium may include, for example, but not limited to, an electrical, magnetic, optical, electromagnetic, infrared, or semiconductor system, apparatus or device, or any combination of any of the above. More specific examples (a non-exhaustive list) of the computer-readable storage medium include: an electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The embodiment of the present disclosure further provides a computer program product, which includes a computer program or a computer instruction, which, in response to being executed by a processor, the image processing method in the embodiment of the present disclosure is realized.

It can be understood that before using the technical solutions disclosed in each embodiment of the present disclosure, a user should be informed of the type, the application scope and the application scenario of personal information involved in the present disclosure in an appropriate way in accordance with relevant laws and regulations and be authorized by the user.

For example, in response to receiving the user's active request, a prompt information is sent to the user to clearly remind the user that the requested operation will require obtaining and using the user's personal information. Therefore, the user can independently choose whether to provide the personal information to software or hardware such as an electronic device, an application, a server or a storage medium that perform the operation of the technical solution of the present disclosure according to the prompt information.

As an optional but non-limiting implementation, in response to receiving the user's active request, a mode to send the prompt information to the user can be, for example, a pop-up window, in which the prompt information can be presented in text. In addition, the pop-up window can also carry a selection control for the user to choose “agree” or “disagree” to provide the personal information to the electronic device.

It can be understood that, the above-mentioned process of notifying and obtaining user authorization is only schematic and does not limit the implementation of the present disclosure, and other modes to satisfy relevant laws and regulations can also be applied to the implementation of the present disclosure.

It should be noted that in the present disclosure, relational terms, such as “first” and “second”, etc., are merely used to distinguish one entity or operation from another entity or operation, and do not necessarily require or imply that there is any such factual relationship or order between these entities or operations. Moreover, the terms “including”, “comprising” or any other variation thereof are intended to cover non-exclusive inclusion, so that a process, method, article or device that includes a series of elements includes not only these elements, but also other elements that are not explicitly listed or elements that are inherent to such process, method, article or device. Without further restrictions, an element defined by the phrase “including a/an . . . ” does not exclude the existence of other identical elements in the process, method, article or device that includes the element.

What is described above is only the specific embodiments of the present disclosure, so that those skilled in the art can understand or realize the present disclosure. Many modifications to these embodiments will be obvious to those skilled in the art, and the general principles defined herein may be implemented in other embodiments without departing from the spirit or scope of the present disclosure. Therefore, the present disclosure is not limited to the embodiments described herein, but to be accorded the widest scope that is consistent with the principles and novel features disclosed herein.

1. An image processing method, comprising:
acquiring a first image;
detecting a feature region in the first image to obtain a detection result of the feature region, wherein the feature region is a region with a specified feature;
determining a first transmissivity corresponding to the first image based on the detection result of the feature region; and
determining an image de-graying intensity based on the first transmissivity, and performing de-graying processing on the first image according to the image de-graying intensity so as to obtain a target image.

2. The method according to claim 1, wherein determining the first transmissivity corresponding to the first image based on the detection result of the feature region, comprises:
acquiring a dark channel map corresponding to the first image;
in case that the detection result of the feature region indicates a presence of the feature region in the first image, determining the first transmissivity corresponding to the first image based on the dark channel map and a comparison result between a region area of the feature region and a preset area threshold; and
in case that the detection result of the feature region indicates an absence of the feature region in the first image, determining the first transmissivity corresponding to the first image based on the dark channel map and a preset light intensity.

3. The method according to claim 2, wherein determining the first transmissivity corresponding to the first image based on the dark channel map and the comparison result between the region area of the feature region and the preset area threshold, comprises:
in case that the region area of the feature region is greater than the preset area threshold, determining a dark channel average value corresponding to the feature region based on the dark channel map, and determining the first transmissivity corresponding to the first image based on the dark channel average value corresponding to the feature region; and
in case that the region area of the feature region is not greater than the preset area threshold, determining the first transmissivity corresponding to the first image based on the dark channel map and the preset light intensity.

4. The method according to claim 3, wherein determining the first transmissivity corresponding to the first image based on the dark channel average value corresponding to the feature region, comprises:
acquiring a second transmissivity corresponding to the feature region based on the dark channel average value corresponding to the feature region;
in case that the second transmissivity is greater than a preset transmissivity upper limit value, enabling the first transmissivity corresponding to the first image to be equal to the transmissivity upper limit value;
in case that the second transmissivity is less than a preset transmissivity lower limit value, enabling the first transmissivity corresponding to the first image to be equal to the transmissivity lower limit value; and
in case that the second transmissivity is between the transmissivity lower limit value and the transmissivity upper limit value, enabling the first transmissivity corresponding to the first image to be equal to the second transmissivity.

5. The method according to claim 2, wherein determining the first transmissivity corresponding to the first image based on the dark channel map and the preset light intensity, comprises:
determining an intermediate transmissivity corresponding to the first image based on the dark channel map and the preset light intensity; and
adjusting the intermediate transmissivity by utilizing a guided filtering algorithm to obtain the first transmissivity.

6. The method according to claim 1, wherein determining the image de-graying intensity based on the first transmissivity, comprises:
acquiring a de-graying intensity set value, and obtaining a reference transmissivity based on the de-graying intensity set value; and
determining the image de-graying intensity based on a maximum value of the reference transmissivity and the first transmissivity.

7. The method according to claim 1, wherein performing the de-graying processing on the first image according to the image de-graying intensity so as to obtain the second image, comprises:
acquiring a de-graying intensity set value, and performing de-mottling processing on the first image based on the de-graying intensity set value to obtain a first intermediate image;
performing de-graying processing on the first intermediate image based on the image de-graying intensity and a preset light intensity to obtain a second intermediate image; and
performing color adjustment processing on a feature region in the second intermediate image to obtain the second image.

8. The method according to claim 7, wherein performing the de-mottling processing on the first image based on the de-graying intensity set value, comprises:
determining a de-mottling intensity based on the de-graying intensity set value; and
based on the de-mottling intensity, performing the de-mottling processing on the first image by utilizing a preset bilateral filtering algorithm, wherein a total number of an associated point corresponding to a pixel point of the first image adopted in the preset bilateral filtering algorithm is a preset value, and a relative positional relationship between the associated point corresponding to the pixel point and the pixel point is a preset relationship.

9. The method according to claim 7, wherein performing the color adjustment processing on the feature region in the second intermediate image to obtain the second image, comprises:
performing the color adjustment processing on the feature region based on a preset saturation adjustment curve and/or a preset brightness adjustment curve to obtain the second image.

10. The method according to claim 1, wherein the feature region comprises a skin region, and the specified feature comprises a skin feature.

11. An electronic device, comprising:
a storage apparatus, wherein a computer program is stored on the storage apparatus; and
a processing apparatus, configured to execute the computer program stored on the storage apparatus to implement:
acquiring a first image;
detecting a feature region in the first image to obtain a detection result of the feature region; wherein the feature region is a region with a specified feature;
determining a first transmissivity corresponding to the first image based on the detection result of the feature region; and
determining an image de-graying intensity based on the first transmissivity, and performing de-graying processing on the first image according to the image de-graying intensity so as to obtain a second image.

12. The electronic device according to claim 11, wherein determining the first transmissivity corresponding to the first image based on the detection result of the feature region, comprises:
acquiring a dark channel map corresponding to the first image;
in case that the detection result of the feature region indicates a presence of the feature region in the first image, determining the first transmissivity corresponding to the first image based on the dark channel map and a comparison result between a region area of the feature region and a preset area threshold; and
in case that the detection result of the feature region indicates an absence of the feature region in the first image, determining the first transmissivity corresponding to the first image based on the dark channel map and a preset light intensity.

13. The electronic device according to claim 12, wherein determining the first transmissivity corresponding to the first image based on the dark channel map and the comparison result between the region area of the feature region and the preset area threshold, comprises:
in case that the region area of the feature region is greater than the preset area threshold, determining a dark channel average value corresponding to the feature region based on the dark channel map, and determining the first transmissivity corresponding to the first image based on the dark channel average value corresponding to the feature region; and
in case that the region area of the feature region is not greater than the preset area threshold, determining the first transmissivity corresponding to the first image based on the dark channel map and the preset light intensity.

14. The electronic device according to claim 13, wherein determining the first transmissivity corresponding to the first image based on the dark channel average value corresponding to the feature region, comprises:
acquiring a second transmissivity corresponding to the feature region based on the dark channel average value corresponding to the feature region;
in case that the second transmissivity is greater than a preset transmissivity upper limit value, enabling the first transmissivity corresponding to the first image to be equal to the transmissivity upper limit value;
in case that the second transmissivity is less than a preset transmissivity lower limit value, enabling the first transmissivity corresponding to the first image to be equal to the transmissivity lower limit value; and
in case that the second transmissivity is between the transmissivity lower limit value and the transmissivity upper limit value, enabling the first transmissivity corresponding to the first image to be equal to the second transmissivity.

15. The electronic device according to claim 12, wherein determining the first transmissivity corresponding to the first image based on the dark channel map and the preset light intensity, comprises:
determining an intermediate transmissivity corresponding to the first image based on the dark channel map and the preset light intensity; and
adjusting the intermediate transmissivity by utilizing a guided filtering algorithm to obtain the first transmissivity.

16. The electronic device according to claim 11, wherein determining the image de-graying intensity based on the first transmissivity, comprises:
acquiring a de-graying intensity set value, and obtaining a reference transmissivity based on the de-graying intensity set value; and
determining the image de-graying intensity based on a maximum value of the reference transmissivity and the first transmissivity.

17. The electronic device according to claim 11, wherein performing the de-graying processing on the first image according to the image de-graying intensity so as to obtain the second image, comprises:
acquiring a de-graying intensity set value, and performing de-mottling processing on the first image based on the de-graying intensity set value to obtain a first intermediate image;
performing de-graying processing on the first intermediate image based on the image de-graying intensity and a preset light intensity to obtain a second intermediate image; and
performing color adjustment processing on a feature region in the second intermediate image to obtain the second image.

18. The electronic device according to claim 17, wherein performing the de-mottling processing on the first image based on the de-graying intensity set value, comprises:
determining a de-mottling intensity based on the de-graying intensity set value; and
based on the de-mottling intensity, performing the de-mottling processing on the first image by utilizing a preset bilateral filtering algorithm; wherein a total number of an associated point corresponding to a pixel point of the first image adopted in the preset bilateral filtering algorithm is a preset value, and a relative positional relationship between the associated point corresponding to the pixel point and the pixel point is a preset relationship.

19. The electronic device according to claim 17, wherein performing the color adjustment processing on the feature region in the second intermediate image to obtain the second image, comprises:
performing the color adjustment processing on the feature region based on a preset saturation adjustment curve and/or a preset brightness adjustment curve to obtain the second image.

20. A computer-readable storage medium, wherein a computer program is stored on the storage medium, and the computer program is configured to execute:
acquiring a first image;
detecting a feature region in the first image to obtain a detection result of the feature region; wherein the feature region is a region with a specified feature;
determining a first transmissivity corresponding to the first image based on the detection result of the feature region; and
determining an image de-graying intensity based on the first transmissivity, and performing de-graying processing on the first image according to the image de-graying intensity so as to obtain a second image.
